(19) United States
(12) Patent Application Publication
(10) Pub. No.: US 2025/0377652 A1
(43) Pub. Date: Dec. 11, 2025

(54) COMPUTER-IMPLEMENTED METHOD FOR CONTROLLING A DYNAMIC SYSTEM

(71) Applicant: Robert Bosch GmbH, Stuttgart (DE)

(72) Inventors: Kevin Schmidt, Herrenberg (DE); Nicola Henkelmann, Vaihingen/Enz (DE); Stefan Gruener, Auenwald (DE); Thomas Specker, Ditzingen (DE)

(21) Appl. No.: 19/229,963

(22) Filed: Jun. 5, 2025

(30) Foreign Application Priority Data
Jun. 7, 2024 (DE) 10 2024 205 238.8

(51) Int. Cl. G05B 23/02

(52) U.S. Cl. CPC G05B 23/024

(57) ABSTRACT

A method for determining system excitations for system identification is disclosed. The method includes (i) receiving a system model, a plurality of system excitations, and a parameter library that comprises at least one parameter to be identified, (ii) determining a plurality of output variables based on the plurality of system excitations and the at least one parameter to be identified using the system model, (iii) determining a plurality of grade measures of the determined plurality of output variables with respect to the at least one parameter to be identified, and (iv) selecting system excitations for system identification based on the determined plurality of grade measures.

This application claims priority under 35 U.S.C. § 119 to application no. DE 10 2024 205 238.8, filed on Jun. 7, 2024 in Germany, the disclosure of which is incorporated herein by reference in its entirety.

### BACKGROUND

Highly automated or autonomous systems are an increasingly important area of focus in the robotics and automotive industries, for example. Control systems in particular are of increasing importance in the operation of autonomous or highly automated systems. In highly automated and autonomous driving, lateral guidance of the vehicle plays a central role. The task of lateral guidance is to keep the lateral spacing of the vehicle to a predetermined path, or to the edge of the lane and/or roadway, respectively, stable. Although numerous control methods have been proposed, they are usually based on nominal models, i.e. uncertainties such as external faults, parameter uncertainties or model errors are not considered.

Uncertainties in the initial states of the control system and the resulting variance in the feedback of the control loop are the result of these uncertainties. The latter are unknown in the development phase and the parameterization of the controller or can be quantified only with difficulty. Therefore, at a later stage in the application phase the controllers must be intensively tested and adjusted against the uncertainties. This is time consuming and costly. Particularly due to the fact that development cycles are increasingly shortening, partially due to increasing software content, market-specific disadvantages result from long product supply times.

The choice of system excitation is essential for the identification of model parameters. The quality of identifiability depends largely on the system input selected. Since the choice of excitation depends not only on parameters of the open circuit but also on the closed control circuit, the question is very system-specific. Thus, there are extensive maneuver catalogs for system identification that are typically based on expert knowledge. Said catalogs are often empirical in nature and optimized over years of application. In particular, if a non-linear system model is present with parameters that can be interpreted physically, there is a lack of analytic methods to determine whether the relevant parameters are at all sufficiently excited for identification. Consequently, the information content of the individual maneuvers for system identification is often unclear. Therefore, there is a need for an improved method of parameter identification in modeling.

### SUMMARY

A first general aspect of the present disclosure relates to a method for determining system excitations for system identification. The method includes receiving a system model, a plurality of system excitations, and a parameter library that comprises at least one parameter to be identified, determining a plurality of output variables based on the plurality of system excitations and the at least one parameter to be identified using the system model, determining a plurality of grade measures of the determined plurality of output variables with respect to the at least one parameter to be identified, and selecting system excitations for system identification based on the determined plurality of grade measures.

A second general aspect of the present disclosure relates to a computer system configured to carry out the method to determine system excitations for system identification according to the first general aspect (or an embodiment thereof).

A third general aspect of the present disclosure relates to a computer program configured to carry out the method to determine system excitations for system identification according to the first general aspect (or an embodiment thereof).

A fourth general aspect of the present disclosure relates to a computer-readable medium or signal, which stores and/or contains the computer program according to the third general aspect (or an embodiment thereof).

The method according to the first general aspect (or an embodiment thereof) proposed in this disclosure may serve to provide a method for determining system excitations for system identification.

Further, the proposed method may serve to provide maneuver catalogs comprising the selected system excitations. In examples, the maneuver catalogs may include the relevant signals or system excitations having the highest information content. Maneuver catalogs, which include more but less relevant signals, can thereby be reduced to the significant signals or system excitations. In examples, the method may result in time and cost savings during system identification. One advantage can be to reduce the time-to-market of highly automated control functions, since relevant parameters can be identified already in the design phase. This can reduce the effort which would need to be expended in the verification/validation phase. If particular parameters cannot be sufficiently identified by way of the existing excitation signals or system excitations, then the maneuver catalog can be systematically extended by specific optimal excitation signals. Another advantage is that, when transitioning to another system, e.g. a new product generation, an existing maneuver catalog can be adapted to the new system. This may enable the transfer of existing expertise to new technology. Further, the techniques of the present disclosures are not limited to vehicle lateral guidance, but may be beneficial for a variety of regulations. In addition to lateral guidance of the vehicle, longitudinal control may also benefit from the techniques of the present disclosure. The present techniques are also advantageous for an approach that simultaneously regulates the longitudinal and lateral guidance.

Some terms are used in the present disclosure in the following manner:

A “state controller” may comprise an algorithm, i.e., a calculation specification, that returns a full or partial state variable (i.e., the internal state of the control section) to an input variable. A state controller may include parameters that can weight the state variable. In examples, a state controller may be executed on a computer system. In examples, a state controller may be executed in a controller of a vehicle, cloud, or edge. For example, a state controller may include or be part of a hardware module having inputs and outputs.

A “vehicle” may be any device that transports passengers and/or freight. A vehicle may be a motor vehicle (for example, a car or a truck) but also a rail vehicle. A vehicle may also be a motorized two or three wheel vehicle. However, floating and flying devices may also be vehicles. Vehicles may be at least partially autonomously operating or assisted.

### BRIEF DESCRIPTION OF THE DRAWINGS

FIG. 1 schematically illustrates a method for determining system excitations for system identification.

FIG. 2 schematically illustrates an exemplary architecture for implementing the method of determining system excitations for system identification.

FIG. 3 illustrates exemplary profiles of grade measures of multiple parameters in an exemplary system excitation.

### DETAILED DESCRIPTION

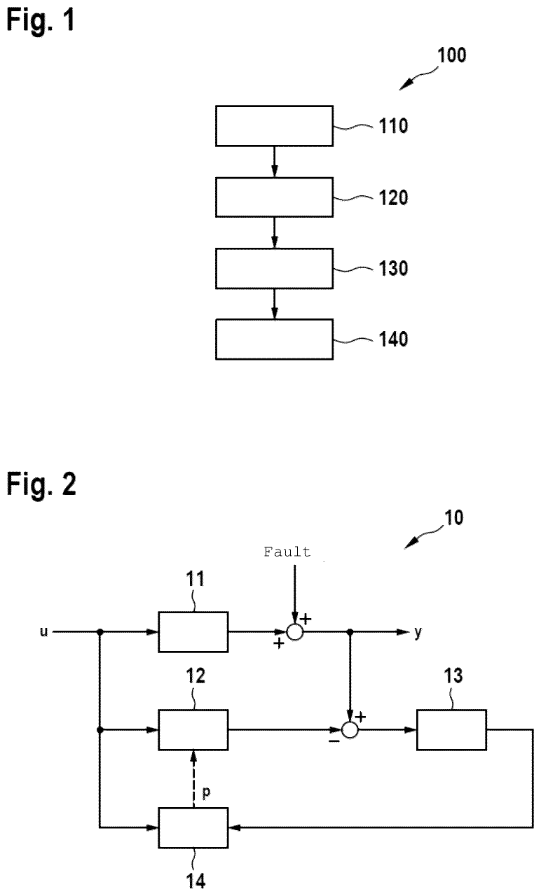

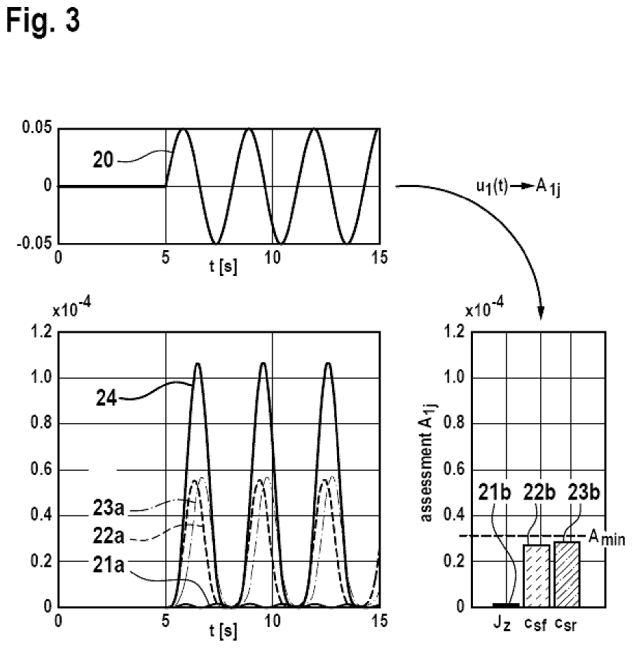

First, the techniques of the present disclosure will be explained with reference to FIG. 1 and FIG. 2. With reference to FIG. 3, possible results and advantages arising from the method of determining system excitations for system identification disclosed herein will be discussed.

FIG. 1 is a flow chart showing possible steps of the method 100 for determining system excitations for system identification. FIG. 2 illustrates an exemplary architecture 10 for implementing the method 100. The method 100 of determining system excitations for system identification comprises receiving 110 a system model 12, a plurality of system excitations, and a parameter library comprising at least one parameter to be identified. In examples, the parameter library may comprise a plurality of parameters to be identified. The method 100 comprises determining 120 a plurality of output variables based on the plurality of system excitations and the at least one parameter to be identified using the system model. The method comprises determining 130 a plurality of grade measures 13 of the determined plurality of output variables with respect to the at least one parameter to be identified. The method comprises selecting 140 system excitations for system identification based on the determined plurality of grade measures. In examples, identifying parameters may comprise determining values for the at least one parameter to be identified.

The following section will begin by explaining a possible basic principle of the method proposed here.

In examples, the system model 12 may serve to replicate the real system 11, as shown in FIG. 2. In examples, a parameterization may be carried out using the at least one parameter to be identified (or the plurality of parameters to be identified) for this purpose. After selecting 140 the system excitations for system identification based on the determined plurality of grade measures, the system excitations for system identification may be applied to the real system 11 to determine one or more, or all, parameters of the at least one parameter to be identified (or the plurality of parameters). The system model 12 and the method proposed herein are used to find system excitations that excite the at least one parameter to be identified. In examples, the identified parameters may be used to parameterize the system model 12.

In examples, determining 120 the plurality of output variables may be carried out by excitation of the system model 12 with the plurality of system excitations. In examples, one system excitation of the plurality of system excitations may be used for each output variable of the plurality of output variables. That is, with reference to FIG. 2, the system model 12 may be excited with one system excitation of the plurality of system excitations, and the output of the system model 12 is the output variable associated with the system excitation used. In examples, as shown in FIG. 2, one grade measure of the plurality of grade measures 13 is based on one output variable of the plurality of output variables. The relationship may be represented as follows: y(t)= [symbol] (u(t), p), wherein [symbol] describes the system model 11.

In examples, the plurality of system excitations may be included in a maneuver catalog. An example for one system excitation of the plurality of system excitations may be a signal, such as a sine function, a cosine function, a jump function, a noise, a ramp function, or a chirp signal, such as a sine chirp or a cosine chirp. In examples, the maneuver catalog may comprise a plurality of maneuvers. In examples, each maneuver of the plurality of maneuvers may be associated with a system excitation. In examples, each maneuver may be associated with an amplitude of the system excitation. In examples, system model 12 may comprise a (dynamic) state space model having internal states. In examples, the state space model may be described time-continuous or time discrete.

In examples, the at least one parameter (or the plurality of parameters) to be identified may comprise at least one parameter for the load-dependent yaw, the mass of the vehicle, the distances of the vehicle center of gravity to the axles, or the roadway friction affecting stiffness (or a combination thereof).

In examples, a probability distribution may be specified for the at least one parameter to be identified. Optionally, if the at least one parameter to be identified comprises a plurality of parameters, a plurality of probability distributions may be provided for the plurality of parameters, optionally different probability distributions. In examples, one parameter p of the at least one parameter to be identified may comprise an equally distributed, uncertain variable with upper and lower limits. In examples, the following may apply: p∈U (p⁻, p⁺) with upper and lower limits p⁻≤p≤p⁺, that limit the parameter range. In examples, one grade measure of the plurality of grade measures 13 may comprise a sensitivity measure. In examples, the sensitivity of Sᵢⱼ an output variable yᵢ of the plurality of output variables with respect to the parameter can pⱼ serve as the grade measure. For example, the sensitivity level may be determined by way of unnormalized Sobol indices. For example, the following may apply:

$${S}_{i j} ( t ) = {𝔼}_{{p}_{\sim j}} [ Va {r}_{{p}_{j}} ( {y}_{i} ( t ) \vert {p}_{∼ j} ) ]$$

wherein pⱼ denotes all parameters except ˜j. In examples, the total effect Sobol Index may be used as the global sensitivity measure Sᵢⱼ. In examples, the first order Sobol index may be used as a grade measure. In examples, a local sensitivity Sᵢⱼ(t)=∂yᵢ(t)/∂pⱼ [symbol] (pⱼ) may be used as a grade measure. In examples, various methods for uncertainty quantification (UQ methods), such as sampling-based Monte-Carlo simulations, Latin-Hypercube sampling, (adaptive) pseudo-spectral projections or intrusive Polynomial Chaos Development (IPCE) may be used to calculate the plurality of grade measures. In examples, the plurality of system excitations may be time dependent. In examples, the plurality of grade measures may be time dependent or comprise a time signal. In examples, the plurality of grade measures may be mapped to scale values by a maximum or L₁ standard.

In examples, the method 100 may comprise gathering the plurality of grade measures in a rating matrix A∈ [symbol] ^{N×n}. In examples, an entry Aᵢⱼ may comprise one grade measure of the plurality of grade measures 13. In other words, an entry Aᵢⱼ may indicate the assessment of the maneuver or system excitation uᵢ(t) with respect to the information about the parameters pⱼ.

In examples, the grade measure for a signal duration of the system excitation of t∈[t₀, t₁] may be integrated over the signal duration and normalized using the signal duration. The following may apply:

$$\frac{1}{{t}_{1} - {t}_{0}} {\int }_{{t}_{0}}^{{t}_{1}} \vert {S}_{i j} ( t ) \vert dt \approx \frac{1}{{t}_{1} - {t}_{0}} {\sum }_{k = 0}^{K} \vert {S}_{ij} ( {t}_{k} ) \vert {w}_{k}$$

In a time discrete case with corresponding sampling rate, the grade measure can be approximated with integration weights wₖ.

In examples, the plurality of grade measures, for example for system models 12 of linear and non-linear dynamic systems, can be determined by intrusive UQ methods. This may serve and/or be advantageous for enabling real-time implementation of the method. A linear state space model may serve as an example:

$$\dot{x} ( t ) = A ( p ) x ( t ) + B ( p ) u ( t ) + E ( p ) w ( p )$$

$$t > {t}_{0} , x ( {t}_{0} ) = {x}_{0} ( p )$$

$$y ( t ) = C ( p ) x ( t ) + D ( p ) u ( t ) .$$

In examples, an input-independent surrogate model may be determined using the IPCE method. In examples, the output variables of the surrogate model may directly comprise the plurality of grade measures, for example the sensitivity measures:

$$\dot{X} ( t ) = {A}^{′} X ( t ) + {B}^{′} u ( t ) + {W}^{′}$$

$$t > {t}_{0} , x ( {t}_{0} ) = {X}_{0}$$

$$S ( t ) = {V}^{′} X ( t ) .$$

This may make it possible to determine the plurality of grade measures, for example the sensitivity measures with a simulation of the surrogate model. In examples, the calculation of the matrices A′, B′, W′, V′ may be performed as part of a pre-processing step. In examples, the determination of the plurality of grade measures can be performed by N simulations of the surrogate model for one system excitation in each case, i.e. one input uᵢ(t). In examples, N may describe the number of maneuvers, i.e., the plurality of system excitations. This may be advantageous to perform the calculation of the plurality of grade measures 13 in a less computationally intensive and/or accelerated manner.

In examples, it may be the case that none of the system excitations of the plurality of system excitations can ensure excitation of a particular parameter of the at least one parameter to be identified (or of the plurality of parameters to be identified).

In examples, the method 100 may comprise reducing the plurality of grade measures by all grade measures 13 with respect to this determined parameter if none of the grade measures 13 satisfy a specified condition with respect to this determined parameter. In examples, the assessment matrix A may be reduced by the corresponding entries A_{(·)j}. In examples, the method may comprise setting the determined parameter to any value. In examples, if the specified condition is not satisfied, it may be assumed that the determined parameter is not relevant and therefore need not be identified. In examples, any value may comprise an expected value of the determined parameter:

$${p}_{j} := 𝔼 ( {p}_{j} ) = \frac{1}{2} ( {p}_{j}^{-} + {p}_{j}^{+} ) .$$

In examples, the method 100 may comprise adding at least one system excitation characterized in that the grade measure 13 of that system excitation satisfies the specified condition with respect to the determined parameter if none of the grade measures 13 satisfies a specified condition with respect to a determined parameter. In examples, the method may comprise performing the method 100 with the added at least one system excitation.

In examples, the specified condition may comprise a minimum value for one grade measure 13 of the plurality of grade measures. In examples, for the specified condition, it may comprise that a grade measure must be greater than or equal to the minimum value to be classified as relevant. In examples, if a grade measure is less than or less than or equal to the minimum value, the specified condition may not be satisfied. For example, the following may apply: A_{(·)j}≤Aₘᵢₙ. That may mean that the specified condition is not satisfied if all system excitations of the plurality of system excitations fail to excite a particular parameter.

FIG. 3 illustrates exemplary profiles of grade measures of multiple parameters in an exemplary system excitation 20.

In this example, for the parameter “inertia”, the sensitivity according to 21a results, for the parameter “curve stiffness front axis” the sensitivity according to 22a, and for the parameter “curve stiffness rear axis” the sensitivity according to 23a. Line 24 represents the cumulative sensitivity. As bars 21b, 22b, and 23b show, no parameter reaches the minimum value Aₘᵢₙ. during excitation of the system model 12 with the system excitation u₁(t)

In examples, the selection 140 of system excitations may be based on a maximum number of system excitations for system identification. In examples, the method 100 may comprise receiving the maximum number. In examples, the selection 140 may represent or comprise a selection method. In examples, selecting 140 the system excitations may comprise selecting system excitations from the originally received plurality of system excitations. In examples, the index quantity [symbol] may comprise the quantity of selected 140 system excitations. For example the following may apply

$$\{ {u}_{i ∈ 𝒥} ( t ) \} = \{ {u}_{1}^{⋆} ( t ) , {u}_{2}^{⋆} ( t ) , … , {u}_{{N}_{r e d}}^{⋆} ( t ) \} ,$$

if N_{red} describes the maximum number of system excitations.

In examples, selecting (140) system excitations may comprise, for each one parameter of the at least one parameter to be identified (or the plurality of parameters to be identified), selecting the maximum grade measure with respect to that parameter, when the maximum number of system excitations is equal to the number of parameters of the at least one parameter to be identified (or the plurality of parameters to be identified). If, for example, as many signals or system excitations as parameters to be identified are desired, it is a good idea to select the respective signal or system excitation can be

$${u}_{j}^{⋆} ( t ) = {u}_{{i}^{⋆} ( j )} ( t )$$

with max. assessment level i*(j)=argmaxᵢ Aᵢⱼ for each parameter pⱼ.

In examples, the selection 140 may be performed through optimization. In examples, the target function of the optimization may comprise the cumulative sums of the grade measures 13 with respect to one parameter in each case. In examples, a Greedy algorithm, a generic algorithm, or another optimization method may be used. In examples, each system excitation or each signal may be assigned an overall rating. In examples, the overall rating may comprise a cumulative selected column sum J( [symbol] )= [symbol] Σⱼ|Aᵢⱼ|. In examples, the target function of the optimization may comprise the cumulative column sum. In examples, a sub-condition of the optimization may comprise a minimum score. In examples, the minimum score may comprise that a grade measure is greater than or equal to a minimum value. In examples, the sub-condition may be represented as follows: [symbol] Aᵢⱼ≥Aₘᵢₙ. In examples, the optimization problem may apply for a fixed maximum number N_{red} for the index quantity [symbol] of the selected system excitations or maneuvers { [symbol] (t)}:

$${max}_{𝒥} \{ J ( 𝒥 ) \vert {max}_{i ∈ 𝒥} {A}_{ij} \geq {A}_{m i n} for all j , \vert 𝒥 \vert = {N}_{red} \}$$

In examples, the method 100 may comprise outputting a recommendation for a choice of the maximum number N_{red}. In examples, the optimization problem can be solved for various values of N_{red}. In examples, a lower limit for the maximum quantity (N_{red}≥N_{red}) may be determined for which the optimization problem has a solution.

In examples, the method 100 may comprise using the selected system excitations to identify the at least one parameter to be identified. In examples, using the selected system excitations may comprise applying the selected system excitations to the real system 11. For example, the method 100 may serve to select the system excitations by way of which the real system 11 is excited by way of the system model 12 to identify or determine the parameters. In examples, the method 100 may be implemented by an algorithm 14, as shown in FIG. 2. In examples, the method 100 may comprise parameterizing the system model 12 using the identified parameters. In examples, the method 100 may comprise parameterizing the system model 12 using the parameters identified by applying the system excitations to the real system 11, as shown in FIG. 2.

In examples, the method 100 may be used for model-based regulation and/or control and/or verification based on a system model 11. In examples, the (parameterized or identified) system model 12 may serve to regulate and/or control the real system 12. In examples, the method 100 for identifying the model parameters for a system model 12 may serve the lateral dynamics of a vehicle. In examples, the system model 12 may form the relationship between the steering angle and vehicle states such as yaw angle, yaw rate, or float angle. In examples, the method 100 may be used to identify the model parameters for a system model 12 of the longitudinal guidance behavior of a vehicle or the steering control (e.g. rack position control) of a vehicle. In examples, the method 100 may be used to identify the model parameters for a system model 12 of the driving dynamics control, the (large-area) robotics, or electrical machines.

In examples, the method 100 may comprise using the (parameterized or identified) system model 12 in a state controller to control the state of a vehicle function, a robot function, a building automation function, a power tool automation function, and/or a household appliance automation function.

In examples, the (parametrized or identified) system model 12 may serve to design a vehicle function, a robot function, a building automation function, power tool automation function, and/or a household appliance automation function.

In examples, the (parameterized or identified) system model 12 may serve to regulate and/or control a real system 11.

In one example, the real system 11 may be configured to be disposed within a vehicle and/or configured to control a vehicle function (in particular, to control a travel function). For example, the vehicle function may be an autonomous and/or assisted driving function. In some examples, the state controller may be configured for execution on a computer system of a vehicle (e.g., an autonomous, highly automated, or assisted driving vehicle). For example, the computer system may be implemented locally in the vehicle or (at least in part) may be implemented in a backend communicatively connected to the vehicle. For example, the computer system may comprise a controller on which the state controller may be executed. In some examples, the vehicle may comprise a computer system having a communication interface that enables communication with a backend. For example, the state controller may be executed in this backend. In one example, the real system 11 may be a system for lateral guidance and/or longitudinal guidance of the vehicle. In examples, a state vector of a state space model of system model 12 may be based on speed information or distance information. In examples, the state vector may comprise a relative speed and/or a distance between a first vehicle, a second vehicle, a human, and/or a stationary object. In one example, a state vector of the state space model may comprise variables that are based at least on one of a steering angle, an orientation angle, a yaw rate, a slip angle, and/or a lateral error. In examples, the state vector may comprise information from a network, such as movement and/or direction information from other vehicles. In examples, this information may be provided by vehicle-to-vehicle (V2V) communication or by a backend (V2X) communication. In one example, an input vector may comprise a steering speed or targets for acceleration and/or braking operations. In examples, the real system 11 may be configured to be disposed in an engine controller or power unit and/or used to regulate an engine-related function (in particular, for engine control). In examples, the real system 11 may be arranged to be disposed in a drive control of an electric machine. For example, the state vector of the state space model may contain variables based on at least one of a control signal, an operation mode, or a power setting of the electric machine.

The present disclosure also relates to methods of controlling and/or regulating a robot using the method 100 proposed herein. In some examples, the state controller, the system model 12 and/or the real system 11 may be configured as described above.

In other examples, the real system 11 may be disposed in a robot and/or configured to control a robot function (in particular to control a movement function of a robot). For example, the real-world system 11 may be a system for lateral guidance and/or longitudinal guidance of the robot. In some examples, the state controller may be executed on a computer system of a robot. For example, the computer system may be implemented locally in the robot or (at least in part) may be implemented in a backend communicatively connected with the robot. In some examples, the state controller may be executed in a backend. In examples, the state vector of a state space model of system model 12 may be based on speed information or distance information. In examples, the state vector may comprise a relative speed and/or a distance between a first robot, a human, another mobile device, and/or a stationary object. In one example, a state vector of the state space model may comprise variables that are based at least on one of a steering angle, an orientation angle, a yaw rate, a slip angle, and/or a lateral error. In examples, the state vector may comprise information from a network, such as movement and/or direction information from other robots, mobile devices, and/or humans. In examples, this information may be provided via direct communication or by a backend. In one example, an input vector may comprise a steering speed or targets for acceleration and/or braking operations.

The present disclosure also relates to methods of controlling and/or regulating functions in building automation using the method 100 proposed herein. In some examples, the state controller, the system model 12 and/or the real system 11 may be configured as described above.

In one example, the real system 11 may be configured to be disposed in a building and/or used to control and/or regulate building functions (in particular, to control and/or regulate building automation functions). For example, the building function may be a function for controlling room temperature, lighting, and/or safety equipment. In some examples, the state controller may be configured to run on a computer system within the building. For example, the computer system may be implemented locally in the building or (at least in part) may be implemented in a backend communicatively connected with the building. For example, the computer system may comprise a control system or a building automation control unit on which the state controller may be executed. In examples, the building may have a computer system having a communication interface that enables communication with an external backend. For example, the state controller may be executed in this backend. A state vector of the state space model of the system model 12 may include variables in examples based on information such as room temperature, brightness, or presence of people. In some cases, the state vector may comprise a relative temperature difference, illuminance, or distance to a particular location or object in the building. An example of a state vector in the context of building automation could include variables based on parameters such as heater control, lighting settings, ventilation speed, or safety alarms. Information in examples may be from a network, such as sensor data or settings from other buildings or building components. This information can be provided through communication between buildings or parts of buildings or via an external backend. In one example, an input vector could comprise, for example, a temperature and/or lighting specification, for example, in the form of a voltage and/or current signal.

A computer system configured to perform the method 100 of determining system excitations for system identification is further disclosed. In examples, the method 100 may be entirely or partially computer-implemented. The computer system may comprise at least one processor and/or at least one working memory. The computer system may further comprise a (non-volatile) memory. In examples, all steps of the method 100 may be performed by the computer system. In some examples, individual steps of method 100 may be performed by the computer system. Optionally, results of individual method steps not performed by the computer system may be received from the computer system via an interface. In examples, the computer system may comprise the state controller.

A computer program configured to perform the method 100 of determining system excitations for system identification is further disclosed. The computer program may, for example, be present in interpretable or compiled form. For execution, it may be loaded (also in portions) into the RAM of a computer, for example, as a bit or byte sequence.

Furthermore disclosed is a computer-readable medium or signal, which stores and/or contains the computer program, or at least a part thereof. The medium may, for example, comprise one of RAM, ROM, EPROM, HDD, SDD, . . . on/in which the signal is stored.

What is claimed is:

1. A method of determining system excitations for system identification, comprising:
receiving a system model, a plurality of system excitations, and a parameter library comprising at least one parameter to be identified;
determining a plurality of output variables based on the plurality of system excitations and the at least one parameter to be identified using the system model;
determining a plurality of grade measures of the determined plurality of output variables with respect to the at least one parameter to be identified; and
selecting system excitations for system identification based on the determined plurality of grade measures.

2. The method according to claim 1, wherein a probability distribution is specified for the at least one parameter to be identified.

3. The method according to claim 1, wherein one grade measure of the plurality of grade measures comprises a sensitivity measure.

4. The method according to claim 1, further comprising:
if none of the grade measures satisfies a specified condition with respect to a determined parameter of the at least one parameter to be identified,
reducing the plurality of grade measures by all grade measures with respect to this determined parameter, and
setting the determined parameter to any value.

5. The method according to claim 1, further comprising:
if none of the grade measures satisfies a specified condition with respect to a determined parameter of the at least one parameter to be identified,
adding at least one system excitation wherein the grade measure of this system excitation satisfies the specified condition with respect to the determined parameter, and
performing the method with the added at least one system excitation.

6. The method according to claim 4, wherein the specified condition comprises a minimum value for a grade measure of the plurality of grade measures.

7. The method according to claim 1, wherein the selection of system excitations is based on a maximum number of system excitations for system identification.

8. The method according to claim 1, wherein the selection of system excitations comprises:
for each parameter of the at least one parameter to be identified, selecting the maximum grade measure with respect to that parameter if the maximum number of system excitations is equal to the number of parameters of the at least one parameter to be identified.

9. The method according to claim 1, wherein the selection is performed by way of an optimization, and wherein the target function of the optimization comprises the cumulative sums of the grade measures with respect to one parameter each.

10. The method according to claim 1, wherein the plurality of grade measures is mapped to scale values by way of a maximum or L₁ standard.

11. The method according to claim 1, further comprising:
using the selected system excitations to identify the at least one parameter to be identified.

12. The method according to claim 1, wherein the system model is used for designing a vehicle function, a robot function, a building automation function, a power tool automation function, and/or a household appliance automation function.

13. A computer system adapted to perform the method of determining system excitations for system identification according to claim 1.

14. A computer program comprising instructions that, when the computer program is executed by a computer system, cause the computer program to perform the method according to claim 1.

15. A computer-readable medium or signal storing and/or containing the computer program according to claim 14.
